(19) United States
(12) Patent Application Publication
(10) Pub. No.: US 2003/0215047 A1
(43) Pub. Date: Nov. 20, 2003

(54) Shield building

(75) Inventors: Hiroe Kobayashi, Yokohama-shi (JP); Tatsuya Fujiwaka, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Ishikawajima-Harima Heavy Industries Co., Ltd., Tokyo (JP)

(21) Appl. No.: 10/422,779

(22) Filed: Apr. 25, 2003

(30) Foreign Application Priority Data
May 16, 2002 (JP) 2002-141668

(51) Int. Cl. G21C 9/00

(52) U.S. Cl. 376/293

(57) ABSTRACT

A shield building peripherally surrounds a containment vessel 3 and has an outer wall 9 with air inlets 4 adjacent to an upper end of the outer wall, a roof 10 contiguous with the upper end of the outer wall 9 having a central opening 12 and an inner wall 11 extending downward from a lower surface of the roof 10 adjacent to a peripheral edge of the roof and facing via gaps 13 and 14 to inner and outer peripheries of the outer wall 9 and containment vessel 3, respectively. The outer and inner walls 9 and 11 and the roof 10 are integrally provided by a steel structure to attain simplification in structure and reduction in quantity of the shield building.

### BACKGROUND OF THE INVENTION

1. Field of the Invention

The present invention relates to a shield building used in a nuclear plant.

2. Description of the Related Art

FIG. 1 shows an example of recently proposed shield buildings for nuclear plants. Arranged in the shield building is a steel containment vessel 3 for encasing a pressurized water reactor 1, a steam generator 2 and associated equipment.

The shield building peripherally surrounding the containment vessel 3 comprises an outer wall 5 with a plurality of air inlets 4 adjacent to an upper end of the outer wall, a roof 6 contiguous with the upper end of the outer wall 5 and gradually convergent upward, a water tank 7 on the roof 6 and a baffle 8 extending downward from a lower surface of the roof 6 adjacent to a peripheral edge of the roof and facing via gaps to inner and outer peripheries of the outer wall 5 and containment vessel 3, respectively.

The above-mentioned outer wall 5, roof 6 and water tank 7 are provided by reinforced concrete constructions and the baffle 8 is provided by a steel structure.

Heat generated from components in the containment vessel 3, in case of an accident, causes air between a top of the containment vessel 3 and the lower surface of the roof 6 to be heated to generate an air flow A flowing through the opening of the roof 6 to outside of and above the shield building, which induces ambient air outside of the shield building to be drawn via the air inlets 4 into the outer wall 5 to generate an air flow B flowing downward through the gap between the outer wall 5 and baffle 8.

This normal-temperature air flow B changes its direction at a lower end of the baffle 8 to flow upward through the gap between the baffle 8 and containment vessel 3, which cools the containment vessel 3 and its interior space.

However, as mentioned above, the shield building shown in FIG. 1 is a composite structure of reinforced concrete constructions with steel structure so that junctions between them become complex in design and in structure and the shield building itself is increased in quantity or becomes voluminous.

Moreover, reinforced concrete constructions need a series of operations of arranging re-bars, arranging a mold, placing concrete into the mold and removing the mold after curing of concrete in the order named, resulting in prolonged operational schedule.

The present invention was made in view of the above and has its object to provide a shield building which is simple in structure and has reduction in quantity.

### BRIEF SUMMARY OF THE INVENTION

In order to attain the above object, a shield building according to the invention comprises an outer wall which peripherally surrounds a containment vessel and has a plurality of air inlets adjacent to an upper end of the outer wall, a roof contiguous with the upper end of the outer wall and having a central opening and an inner wall extending from a lower surface of the roof and adjacent to a peripheral edge of the roof and facing via gaps to inner and outer peripheries of the outer wall and containment vessel, respectively, the outer and inner walls and the roof being provided by a steel structure.

Thus, according to the invention, the steel structure integrally provides the outer and inner walls and the roof to facilitate simplification in structure and reduction in quantity of the shield building.

According to the shield building of the invention, inner and outer peripheries of the outer and inner walls, respectively, may be fixed to each other through reinforcing members for improvement in strength.

According to the shield building of the invention, a steel formwork and wall may be arranged to peripherally surround the outer wall and a gap between the outer wall and the formwork and wall may be filled with radiation shielding material so as to improve radiation shielding ability.

According to the shield building of the invention, a space between the outer and inner walls may be filled with radiation shielding material so as to leave voids for air flow, thereby assuring radiation shielding ability.

### BRIEF DESCRIPTION OF THE DRAWINGS

FIG. 1 is a schematic view showing a conventional shield building;

FIGS. 2, 3 and 4 are schematic views showing first, second and third embodiments of a shield building according to the invention, respectively; and

FIG. 5 is an enlarged view looking in the direction of arrows V in FIG. 4.

### DETAILED DESCRIPTION OF THE PREFERRED EMBODIMENTS

Preferred embodiments of the invention will be described in conjunction with the drawings.

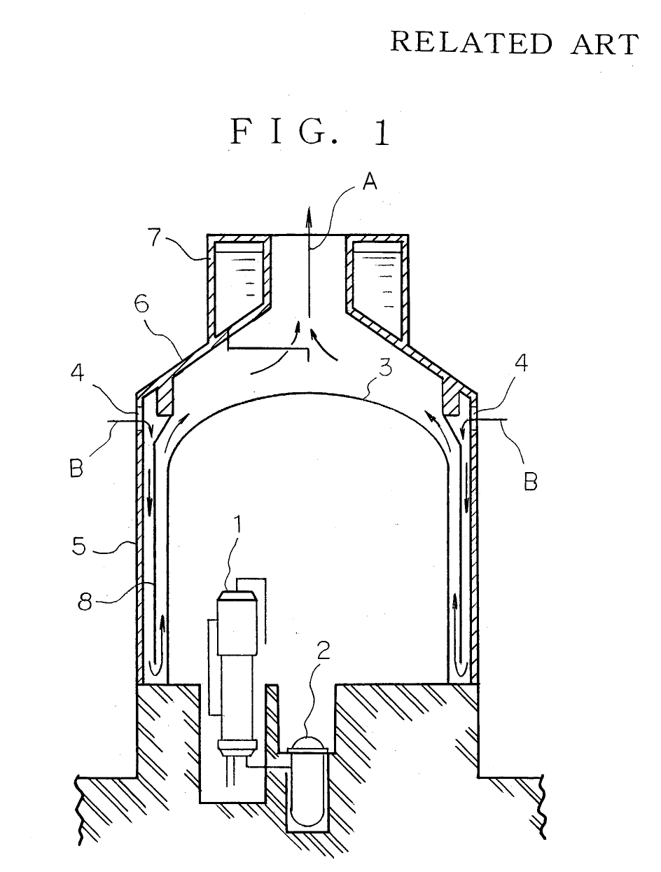

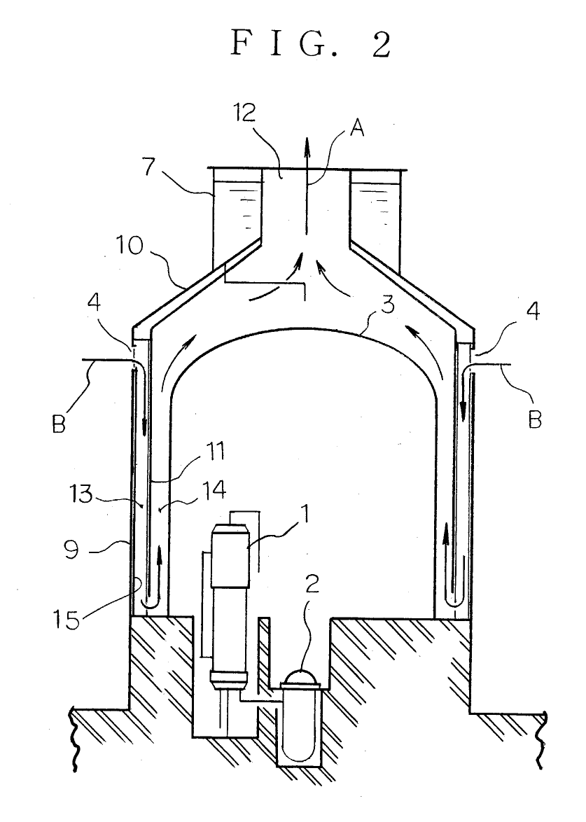

FIG. 2 shows a first embodiment of a shield building according to the invention in which parts similar to those in FIG. 1 are referred to by the same reference numerals.

This shield building comprises outer and inner walls 9 and 11 a roof 10 which are integrally provided by a steel structure.

The outer wall 9 peripherally surrounds a containment vessel 3 and has a plurality of air inlets 4 arranged peripherally equidistantly on the outer wall 9 adjacent to an upper end of the outer wall.

The roof 10 is contiguous with the upper end of the outer wall 9 and converges upward to have an opening 12 which extends from an interior space of and through the roof 10 to outside of and above the roof 10 and is surrounded at its periphery with a water tank 7.

The inner wall 11 extends downward from a lower surface of the roof 10 adjacent to a peripheral edge of the roof to a position adjacent to a floor surface and faces via gaps 13 and 14 to inner and outer peripheries of the outer wall 9 and containment vessel 3, respectively.

The inner and outer peripheries of the outer and inner walls 9 and 11, respectively, are fixed to each other via a plurality of reinforcing members 15. The reinforcing members 15 extend substantially vertically and are arranged horizontally between the outer and inner walls 9 and 11 circumferentially equidistantly of the walls.

In the shield building shown in FIG. 2, heat generated from components in the containment vessel 3, in case of an accident, causes air between a top of the containment vessel 3 and the lower surface of the roof 10 to be heated to generate an air flow A flowing upward via the opening 12 of the roof 10 to outside of and above the shield building, which induces ambient air outside of the shield building to be drawn via the air inlets 4 into the outer wall 9 to generate an air flow B which flows through a gap 13 between the inner and outer peripheries of the outer and inner walls 9 and 11, respectively.

This normal-temperature air flow B changes its direction at the lower end of the inner wall 11 to flow upward through a gap 14 between the inner wall 11 and the containment vessel 3, which cools the containment vessel 3 and its interior space.

Thus, according to the shield building of the invention shown in FIG. 2, the outer and inner walls 9 and 11 and the roof 10 are integrally provided by a steel structure, resulting in simplification in structure and reduction in quantity of the shield building.

The outer and inner walls 9 and 11 are fixed to each other via the reinforcing members 15 arranged circumferentially equidistantly of the walls, leading to improvement in strength of the shield building.

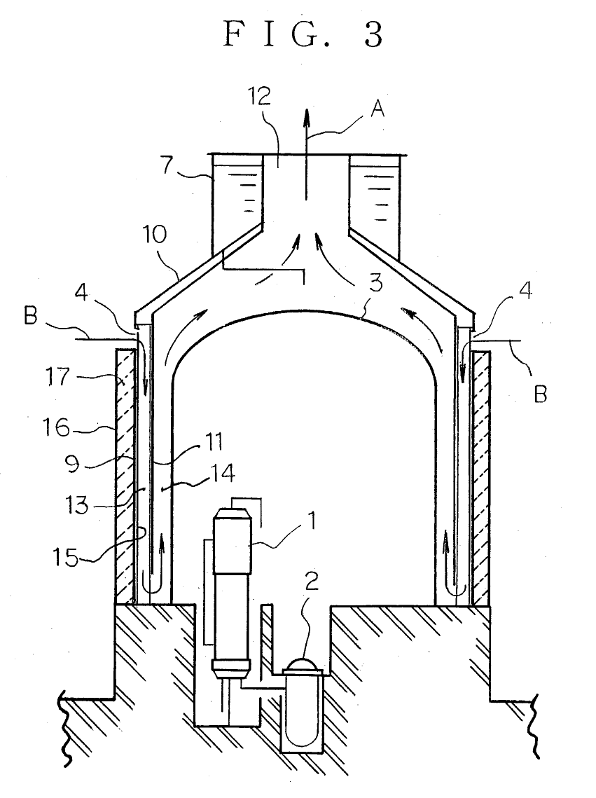

FIG. 3 shows a second embodiment of a shield building according to the invention in which parts similar to those in FIG. 2 are referred to by the same reference numerals.

This shield building has a steel formwork and wall 16 which peripherally surrounds the outer wall 9. A gap between the outer wall 9 and the formwork and wall 16 is filled with radiation shielding material 17 such as concrete so as to improve radiation shielding ability.

The formwork and wall 16, which is not a temporary structure and needs not to be removed, relieves associated works with respect to filling of the radiation shielding material 17.

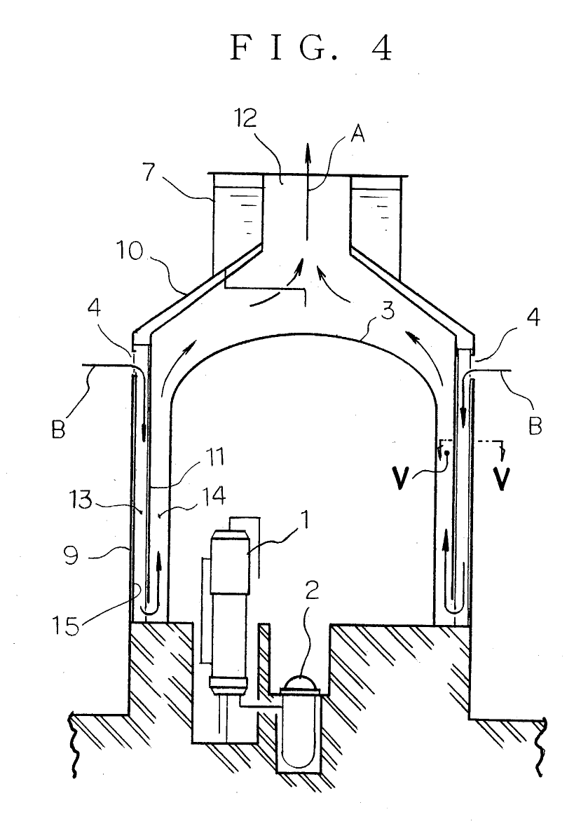

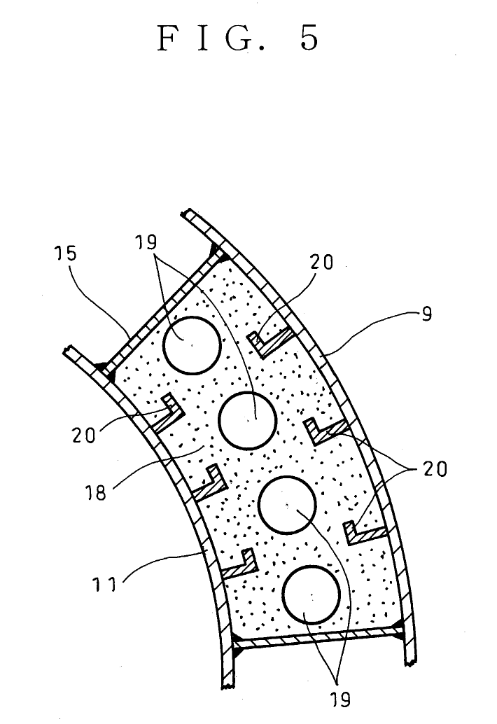

FIGS. 4 and 5 show a third embodiment of the invention in which parts similar to those in FIGS. 2 and 3 are referred to by the same reference numerals.

In this embodiment, a gap 13 between the outer and inner walls 9 and 11 is filled with radiation shielding material 18 such as concrete so as to leave voids 19 serving as ducts for assurance of air flow B. Upper ends of the voids 19 communicate with air inlets 4 on the outer wall 9 adjacent to an upper end of the outer wall; and lower ends of the voids 19, with a gap 14 between the inner wall 11 and a containment vessel 3. In FIG. 5, reference numeral 20 denotes reinforcing members.

In this shield building, the gap between the outer and inner walls 9 and 11 is filled with the radiation shielding material 18 to assure radiation shielding ability.

It is to be understood that the inventive is not limited to the above embodiments and that various changes and modifications may be made without departing from the scope and spirit of the invention.

What is claimed is:

1. A shield building comprising an outer wall for peripherally surrounding a containment vessel and having a plurality of air inlets adjacent to an upper end of the outer wall, a roof contiguous with the upper end of the outer wall and having a central opening and an inner wall extending downward from a lower surface of the roof adjacent to a peripheral edge of the roof and facing via gaps to inner and outer peripheries of the outer wall and the containment vessel, respectively, the outer and inner walls and the roof being provided by a steel structure.

2. A shield building according to claim 1 wherein inner and outer peripheries of the outer and inner walls, respectively, are fixed to each other through reinforcing members.

3. A shield building according to claim 1 further comprising a steel formwork and wall for peripherally surrounding the outer wall, a gap between the outer wall and the formwork and wall being filled with radiation shielding material.

4. A shield building according to claim 2 further comprising a steel formwork and wall for peripherally surrounding the outer wall, a gap between the outer wall and the formwork and wall being filled with radiation shielding material.

5. A shield building according to claim 1 wherein the gap between the outer and inner walls is filled with radiation shielding material so as to leave voids for assurance of air flow.

6. A shield building according to claim 2 wherein the gap between the outer and inner walls is filled with radiation shielding material so as to leave voids for assurance of air flow.

7. A shield building according to claim 3 wherein the gap between the outer and inner walls is filled with radiation shielding material so as to leave voids for assurance of air flow.

8. A shield building according to claim 4 wherein the gap between the outer and inner walls is filled with radiation shielding material so as to leave voids for assurance of air flow.
